(19) United States
(12) Patent Application Publication
(10) Pub. No.: US 2025/0389860 A1
(43) Pub. Date: Dec. 25, 2025

(54) ELASTIC FULL WAVE INVERSION WITH MACHINE LEARNING ESTIMATED ELASTIC PROPERTIES

(71) Applicant: Schlumberger Technology Corporation, Sugar Land, TX (US)

(72) Inventors: Wenyi Hu, Fulshear, TX (US); Haibin Di, Houston, TX (US); Aria Abubakar, Sugar Land, TX (US)

(21) Appl. No.: 19/243,143

(22) Filed: Jun. 19, 2025

Related U.S. Application Data
(60) Provisional application No. 63/661,927, filed on Jun. 20, 2024.

(51) Int. Cl. G01V 1/30

(52) U.S. Cl. CPC G01V 1/306; G01V 2210/51; G01V 2210/6222; G01V 2210/6242

(57) ABSTRACT

A method for performing an elastic full wave inversion (FWI) includes generating an initial P wave velocity model. The method also includes producing a subsurface seismic image or an image gather based upon the initial P wave velocity model. The method also includes estimating elastic properties based upon the subsurface seismic image or the image gather. The method also includes performing elastic full wave inversion (FWI) on the initial P wave velocity model and the elastic properties to produce updated elastic properties.

### CROSS-REFERENCE TO RELATED APPLICATIONS

This application claims priority to and the benefit of U.S. Provisional Patent Application No. 63/661,927, filed on Jun. 20, 2024, which is incorporated by reference herein in its entirety.

### BACKGROUND

Full waveform inversion (FWI) is an advanced seismic data processing technology that is used to reconstruct the subsurface geophysical properties such as seismic velocity models and/or bulk density models. Full waveform inversion is based on nonlinear inversion. The inversion process starts from initial subsurface geophysical property models. Simulated wavefields are generated based upon these initial geophysical property models by running a forward modeling engine embedded in the FWI module. The simulated wavefields are then compared with the measured data to calculate the residual, which is minimized by updating the initial geophysical property models in an iterative manner until the inversion process converges.

Conventionally, FWI is implemented with the acoustic assumption, ignoring the shear wave energy in the forward modeling engine and the inversion algorithm, which leads to inaccurate solutions. In recent years, the industry has been emphasizing the elastic properties of the Earth and is starting to take into account the Earth' elastic properties in FWI. Unfortunately, it is challenging to estimate the initial S-wave velocity model to launch the FWI. It is also challenging to update the P-wave velocity Vp and the S-wave velocity Vs simultaneously during the FWI inversion process.

In addition, some conventional practices in the industry include estimating an initial Vs mode using a constant Vp-to-Vs ratio to start the FWI process. During the FWI inversion, the initial Vs is fixed, and the Vp model is updated iteratively. The Vp-to-Vs ratio is often derived from the well logs. This ratio varies from location to location and from depth to depth. A constant Vp-to-Vs ratio may inevitably induce errors in the FWI results.

Therefore, what is needed is a system and method that improve the accuracy of elastic FWI by providing a more accurate initial Vs model estimated by a deep learning method.

### SUMMARY

A method for performing an elastic full wave inversion (FWI) is disclosed. The method includes generating an initial P wave velocity model. The method also includes producing a subsurface seismic image or an image gather based upon the initial P wave velocity model. The method also includes estimating elastic properties based upon the subsurface seismic image or the image gather. The method also includes performing elastic full wave inversion (FWI) on the initial P wave velocity model and the elastic properties to produce updated elastic properties.

A computing system is also disclosed. The computing system includes one or more processors and a memory system. The memory system includes one or more non-transitory computer-readable media storing instructions that, when executed by at least one of the one or more processors, cause the computing system to perform operations. The operations include generating an initial P wave velocity model. The initial P wave velocity model is generated using velocity tomography or a velocity model building process. The operations also include producing a subsurface seismic image or an image gather based upon the initial P wave velocity model. The subsurface seismic image or the image gather is produced using a migration engine. The operations also include estimating elastic properties based upon the subsurface seismic image or the image gather. The elastic properties are estimated using a machine learning (ML) neural network (NN). The elastic properties include an estimated S wave velocity model and/or an estimated density model. The operations also include performing elastic full wave inversion (FWI) on the initial P wave velocity model and the elastic properties to produce updated elastic properties. The updated elastic properties include an updated P wave velocity model. The operations also include producing an updated subsurface seismic image and/or an updated image gather based upon the updated elastic properties. The updated subsurface seismic image and/or the updated image gather are produced based upon the updated P wave velocity model.

A non-transitory computer-readable medium is also disclosed. The medium stores instructions that, when executed by one or more processors of a computing system, cause the computing system to perform operations. The operations include generating an initial P wave velocity model. The initial P wave velocity model is generated using velocity tomography or a velocity model building process. The operations also include producing a subsurface seismic image or an image gather based upon the initial P wave velocity model. The subsurface seismic image or the image gather is produced using a migration engine. The migration engine is a Kirchhoff migration engine, a one-way wave equation migration engine, a beam migration engine, or a reverse time migration engine. The operations also include interpreting the subsurface seismic image or the image gather to produce a stratigraphy model. The subsurface seismic image or the image gather is interpreted using horizon picking, fault system picking, relative geologic time model generation, or facies classification. The operations also include estimating elastic properties based upon the subsurface seismic image or the image gather and the stratigraphy model. The elastic properties are estimated using a machine learning (ML) neural network (NN). The elastic properties include an estimated S wave velocity model and an estimated density model. The elastic properties are estimated in a spatial domain or a time domain by utilizing well log data located in the spatial domain or the time domain. Estimating the elastic properties comprises mapping traces extracted from the subsurface seismic image or the image gather to the well log data located at the same locations in a network training phase with constraints from the stratigraphy model to produce a trained network. The trained model is then applied to the traces from the subsurface seismic image or image gathers to map them into the corresponding elastic properties. The operations also include processing the elastic properties to produce processed elastic properties. Processing includes smoothing, denoising, or both. The operations also include performing elastic full wave inversion (FWI) on the initial P wave velocity model and the processed elastic properties to produce updated elastic properties. The updated elastic properties include an updated P wave velocity model, an updated S wave velocity model, and/or an updated density model. The elastic FWI is not performed on an estimated P wave velocity model. The operations also include producing an updated subsurface seismic image and/or an updated image gather based upon the updated elastic properties. The updated subsurface seismic image and/or the updated image gather are produced based upon the updated P wave velocity model.

It will be appreciated that this summary is intended merely to introduce some aspects of the present methods, systems, and media, which are more fully described and/or claimed below. Accordingly, this summary is not intended to be limiting.

### BRIEF DESCRIPTION OF THE DRAWINGS

The accompanying drawings, which are incorporated in and constitute a part of this specification, illustrate embodiments of the present teachings and together with the description, serve to explain the principles of the present teachings. In the figures:

FIG. 1 illustrates an example of a system that includes various management components to manage various aspects of a geologic environment, according to an embodiment.

FIG. 2 illustrates a workflow of an elastic FWI, according to an embodiment.

FIG. 3 illustrates a method for performing a ML-assisted elastic FWI, according to an embodiment.

FIG. 4 illustrates a schematic view of a neural network for elastic property model building from seismic image gathers, according to an embodiment.

FIG. 5A illustrates a seismic image that may be input into the network, FIG. 5B illustrates an image showing the Rho, FIG. 5C illustrates an image showing the predicted P-slowness, and FIG. 5D illustrates an image showing the S-slowness, according to an embodiment.

FIG. 6 illustrates a schematic view of a computing system for performing at least a portion of the method(s) described herein, according to an embodiment.

### DETAILED DESCRIPTION

Reference will now be made in detail to embodiments, examples of which are illustrated in the accompanying drawings and figures. In the following detailed description, numerous specific details are set forth in order to provide a thorough understanding of the present disclosure. However, it will be apparent to one of ordinary skill in the art that the present disclosure may be practiced without these specific details. In other instances, well-known methods, procedures, components, circuits, and networks have not been described in detail so as not to unnecessarily obscure aspects of the embodiments.

It will also be understood that, although the terms first, second, etc. may be used herein to describe various elements, these elements should not be limited by these terms. These terms are only used to distinguish one element from another. For example, a first object or step could be termed a second object or step, and, similarly, a second object or step could be termed a first object or step, without departing from the scope of the present disclosure. The first object or step, and the second object or step, are both, objects or steps, respectively, but they are not to be considered the same object or step.

The terminology used in the description herein is for the purpose of describing particular embodiments and is not intended to be limiting. As used in this description and the appended claims, the singular forms “a,” “an” and “the” are intended to include the plural forms as well, unless the context clearly indicates otherwise. It will also be understood that the term “and/or” as used herein refers to and encompasses any possible combinations of one or more of the associated listed items. It will be further understood that the terms “includes,” “including,” “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Further, as used herein, the term “if” may be construed to mean “when” or “upon” or “in response to determining” or “in response to detecting,” depending on the context.

Attention is now directed to processing procedures, methods, techniques, and workflows that are in accordance with some embodiments. Some operations in the processing procedures, methods, techniques, and workflows disclosed herein may be combined and/or the order of some operations may be changed.

### System Overview

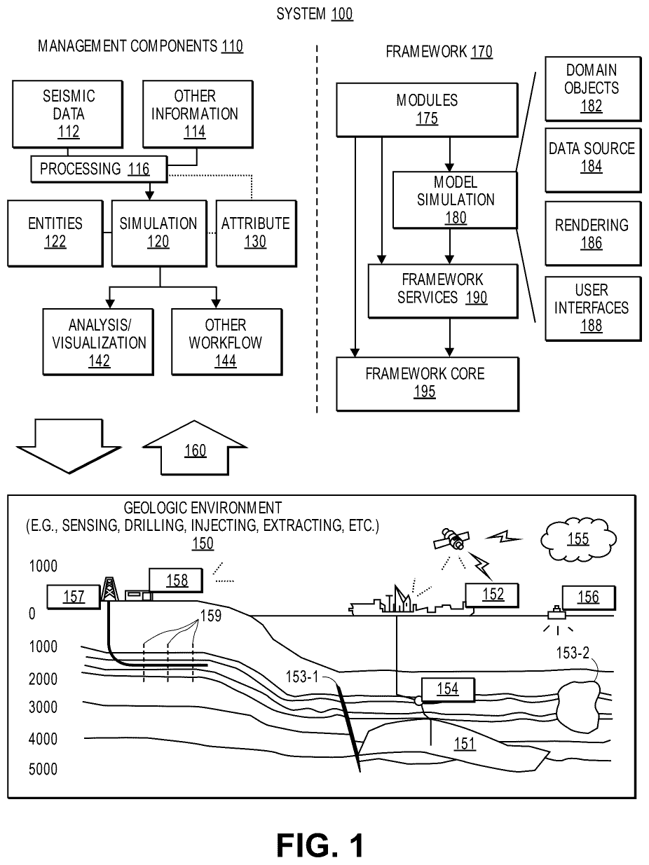

FIG. 1 illustrates an example of a system 100 that includes various management components 110 to manage various aspects of a geologic environment 150 (e.g., an environment that includes a sedimentary basin, a reservoir 151, one or more faults 153-1, one or more geobodies 153-2, etc.). For example, the management components 110 may allow for direct or indirect management of sensing, drilling, injecting, extracting, etc., with respect to the geologic environment 150. In turn, further information about the geologic environment 150 may become available as feedback 160 (e.g., optionally as input to one or more of the management components 110).

In the example of FIG. 1, the management components 110 include a seismic data component 112, an additional information component 114 (e.g., well/logging data), a processing 116, a simulation component 120, an attribute component 130, an component analysis/visualization component 142 and a workflow component 144. In operation, seismic data and other information provided per the components 112 and 114 may be input to the simulation component 120.

In an example embodiment, the simulation component 120 may rely on entities 122. Entities 122 may include earth entities or geological objects such as wells, surfaces, bodies, reservoirs, etc. In the system 100, the entities 122 can include virtual representations of actual physical entities that are reconstructed for purposes of simulation. The entities 122 may include entities based on data acquired via sensing, observation, etc. (e.g., the seismic data 112 and other information 114). An entity may be characterized by one or more properties (e.g., a geometrical pillar grid entity of an earth model may be characterized by a porosity property). Such properties may represent one or more measurements (e.g., acquired data), calculations, etc.

In an example embodiment, the simulation component 120 may operate in conjunction with a software framework such as an object-based framework. In such a framework, entities may include entities based on pre-defined classes to facilitate modeling and simulation. A commercially available example of an object-based framework is the MICROSOFT® .NET® framework (Redmond, Washington), which provides a set of extensible object classes. In the .NET® framework, an object class encapsulates a module of reusable code and associated data structures. Object classes can be used to instantiate object instances for use in by a program, script, etc. For example, borehole classes may define objects for representing boreholes based on well data.

In the example of FIG. 1, the simulation component 120 may process information to conform to one or more attributes specified by the attribute component 130, which may include a library of attributes. Such processing may occur prior to input to the simulation component 120 (e.g., consider the processing component 116). As an example, the simulation component 120 may perform operations on input information based on one or more attributes specified by the attribute component 130. In an example embodiment, the simulation component 120 may construct one or more models of the geologic environment 150, which may be relied on to simulate behavior of the geologic environment 150 (e.g., responsive to one or more acts, whether natural or artificial). In the example of FIG. 1, the analysis/visualization component 142 may allow for interaction with a model or model-based results (e.g., simulation results, etc.). As an example, output from the simulation component 120 may be input to one or more other workflows, as indicated by a workflow component 144.

As an example, the simulation component 120 may include one or more features of a simulator such as the ECLIPSE™ reservoir simulator (SLB, Houston Texas), the INTERSECT™ reservoir simulator (SLB, Houston Texas), etc. As an example, a simulation component, a simulator, etc. may include features to implement one or more meshless techniques (e.g., to solve one or more equations, etc.). As an example, a reservoir or reservoirs may be simulated with respect to one or more enhanced recovery techniques (e.g., consider a thermal process such as SAGD, etc.).

As an example, the simulation component 120 may include one or more features of a simulator such as SYMMETRY software (SLB, Houston, Texas). More particularly, SYMMETRY may process workflows in a single integrated environment with accurate thermodynamic fluid representation and consistent modeling across multiple disciplines including process, production, and HSE. The simulator integrates steady-state and transient (e.g., dynamic) analyses that can be tailored for each domain. This approach enables users to optimize processes in upstream, midstream, and downstream sectors while maximizing profits and minimizing capital expenditures. It may also help reduce emissions, energy consumption, and waste.

As an example, the simulation component 120 may include one or more features of a simulator such as PIPESIM (SLB, Houston, Texas). More particularly, PIPESIM is steady-state multiphase flow simulator that incorporates the three areas of flow modeling: multiphase flow, heat transfer and fluid behavior.

As an example, the simulation component 120 may include one or more features of a simulator such as OLGA™ (SLB, Houston, Texas). More particularly, OLGA™ is a dynamic multiphase flow simulator that models transient flow (e.g., time-dependent behaviors) to maximize production potential. Transient modeling is a component for feasibility studies and field development design. Dynamic simulation is useful in deep water and is used in both offshore and onshore developments to investigate transient behavior in pipelines and wellbores. Transient simulation with the OLGA™ simulator provides an added dimension to steady-state analysis by predicting system dynamics, such as time-varying changes in flow rates, fluid compositions, temperature, solids deposition, and operational changes.

In an example embodiment, the management components 110 may include features of a commercially available framework such as the PETREL® seismic to simulation software framework (SLB, Houston, Texas). The PETREL® framework provides components that allow for optimization of exploration and development operations. The PETREL® framework includes seismic to simulation software components that can output information for use in increasing reservoir performance, for example, by improving asset team productivity. Through use of such a framework, various professionals (e.g., geophysicists, geologists, and reservoir engineers) can develop collaborative workflows and integrate operations to streamline processes. Such a framework may be considered an application and may be considered a data-driven application (e.g., where data is input for purposes of modeling, simulating, etc.).

In an example embodiment, various aspects of the management components 110 may include add-ons or plug-ins that operate according to specifications of a framework environment. For example, a commercially available framework environment marketed as the OCEAN® framework environment (SLB, Houston, Texas) allows for integration of add-ons (or plug-ins) into a PETREL® framework workflow. The OCEAN® framework environment leverages .NET® tools (Microsoft Corporation, Redmond, Washington) and offers stable, user-friendly interfaces for efficient development. In an example embodiment, various components may be implemented as add-ons (or plug-ins) that conform to and operate according to specifications of a framework environment (e.g., according to application programming interface (API) specifications, etc.).

FIG. 1 also shows an example of a framework 170 that includes a model simulation layer 180 along with a framework services layer 190, a framework core layer 195 and a modules layer 175. The framework 170 may include the commercially available OCEAN® framework where the model simulation layer 180 is the commercially available PETREL® model-centric software package that hosts OCEAN® framework applications. In an example embodiment, the PETREL® software may be considered a data-driven application. The PETREL® software can include a framework for model building and visualization.

As an example, a framework may include features for implementing one or more mesh generation techniques. For example, a framework may include an input component for receipt of information from interpretation of seismic data, one or more attributes based at least in part on seismic data, log data, image data, etc. Such a framework may include a mesh generation component that processes input information, optionally in conjunction with other information, to generate a mesh.

In the example of FIG. 1, the model simulation layer 180 may provide domain objects 182, act as a data source 184, provide for rendering 186 and provide for various user interfaces 188. Rendering 186 may provide a graphical environment in which applications can display their data while the user interfaces 188 may provide a common look and feel for application user interface components.

As an example, the domain objects 182 can include entity objects, property objects and optionally other objects. Entity objects may be used to geometrically represent wells, surfaces, bodies, reservoirs, etc., while property objects may be used to provide property values as well as data versions and display parameters. For example, an entity object may represent a well where a property object provides log information as well as version information and display information (e.g., to display the well as part of a model).

In the example of FIG. 1, data may be stored in one or more data sources (or data stores, generally physical data storage devices), which may be at the same or different physical sites and accessible via one or more networks. The model simulation layer 180 may be configured to model projects. As such, a particular project may be stored where stored project information may include inputs, models, results and cases. Thus, upon completion of a modeling session, a user may store a project. At a later time, the project can be accessed and restored using the model simulation layer 180, which can recreate instances of the relevant domain objects.

In the example of FIG. 1, the geologic environment 150 may include layers (e.g., stratification) that include a reservoir 151 and one or more other features such as the fault 153-1, the geobody 153-2, etc. As an example, the geologic environment 150 may be outfitted with any of a variety of sensors, detectors, actuators, etc. For example, equipment 152 may include communication circuitry to receive and to transmit information with respect to one or more networks 155. Such information may include information associated with downhole equipment 154, which may be equipment to acquire information, to assist with resource recovery, etc. Other equipment 156 may be located remote from a well site and include sensing, detecting, emitting or other circuitry. Such equipment may include storage and communication circuitry to store and to communicate data, instructions, etc. As an example, one or more satellites may be provided for purposes of communications, data acquisition, etc. For example, FIG. 1 shows a satellite in communication with the network 155 that may be configured for communications, noting that the satellite may additionally or instead include circuitry for imagery (e.g., spatial, spectral, temporal, radiometric, etc.).

FIG. 1 also shows the geologic environment 150 as optionally including equipment 157 and 158 associated with a well that includes a substantially horizontal portion that may intersect with one or more fractures 159. For example, consider a well in a shale formation that may include natural fractures, artificial fractures (e.g., hydraulic fractures) or a combination of natural and artificial fractures. As an example, a well may be drilled for a reservoir that is laterally extensive. In such an example, lateral variations in properties, stresses, etc. may exist where an assessment of such variations may assist with planning, operations, etc. to develop a laterally extensive reservoir (e.g., via fracturing, injecting, extracting, etc.). As an example, the equipment 157 and/or 158 may include components, a system, systems, etc. for fracturing, seismic sensing, analysis of seismic data, assessment of one or more fractures, etc.

As mentioned, the system 100 may be used to perform one or more workflows. A workflow may be a process that includes a number of worksteps. A workstep may operate on data, for example, to create new data, to update existing data, etc. As an example, a may operate on one or more inputs and create one or more results, for example, based on one or more algorithms. As an example, a system may include a workflow editor for creation, editing, executing, etc. of a workflow. In such an example, the workflow editor may provide for selection of one or more pre-defined worksteps, one or more customized worksteps, etc. As an example, a workflow may be a workflow implementable in the PETREL® software, for example, that operates on seismic data, seismic attribute(s), etc. As an example, a workflow may be a process implementable in the OCEAN® framework. As an example, a workflow may include one or more worksteps that access a module such as a plug-in (e.g., external executable code, etc.).

Elastic Full Waveform Inversion with Machine Learning Estimated Elastic Properties

The present disclosure proposes a deep learning method to estimate a shear wave velocity model (Vs) from a migration image or migration image gathers to improve the accuracy of elastic full waveform inversion (FWI).

### Workflow of an Elastic FWI

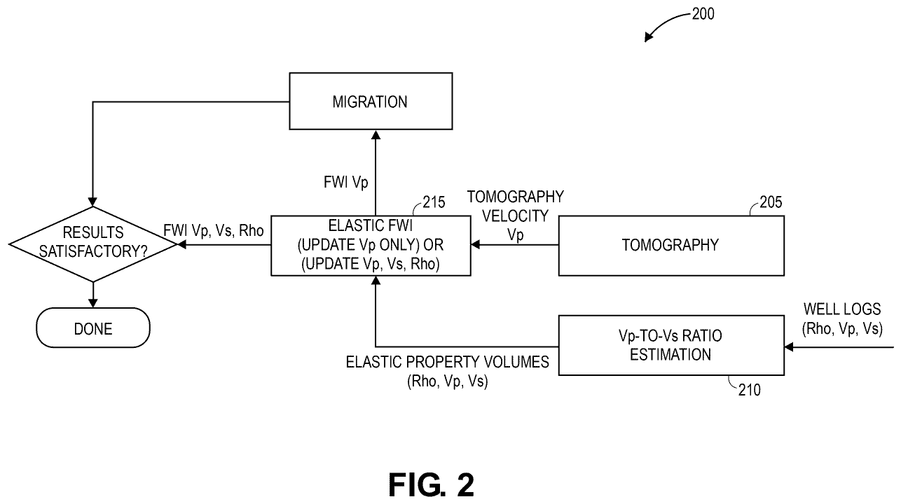

FIG. 2 illustrates a workflow 200 of an elastic FWI, according to an embodiment. First, a P wave velocity tomography or P wave velocity model building process may be implemented to obtain a kinematically accurate but relatively smooth P wave velocity model Vp, as at 205. This velocity model Vp may then be input into the elastic FWI engine as the initial P wave velocity model.

For elastic FWI, the P wave velocity model may not be sufficient to launch the inversion process. One option is to analyze the available well logs (e.g., P wave velocity log Vp, shear wave velocity log Vs, and/or density log Rho) to estimate a constant or spatially varying Vp-to-Vs ratio, as at 210. This ratio may be applied to the whole 3D volume to derive a 3D Vs model from the Vp model. Another option is to propagate (e.g., extrapolate) the Vs value at the well locations to the entire 3D volume with a structural constraint. The density can be estimated from the Vp using the Gardner Law. The density Rho may be assumed to be a constant value in the whole spatial domain.

The estimated Vs and the density Rho may be input into the elastic FWI engine, along with the Vp, as the initial models for the elastic FWI update, as at 215. During the elastic FWI process, the Vp may be updated iteratively to make the simulated seismic data gradually match the measured seismic data. The Vs and Rho may be updated as well during the elastic FWI process.

### Exemplary Workflow of a ML-Assisted Elastic FWI

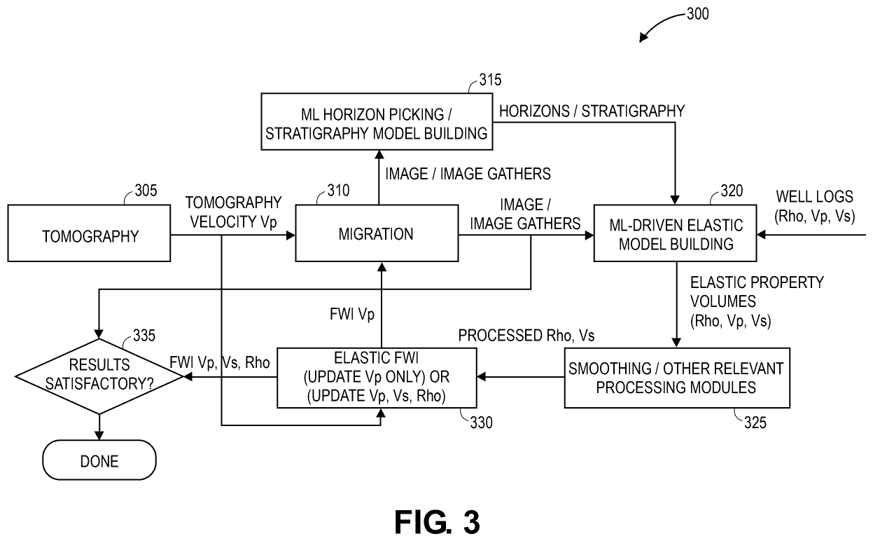

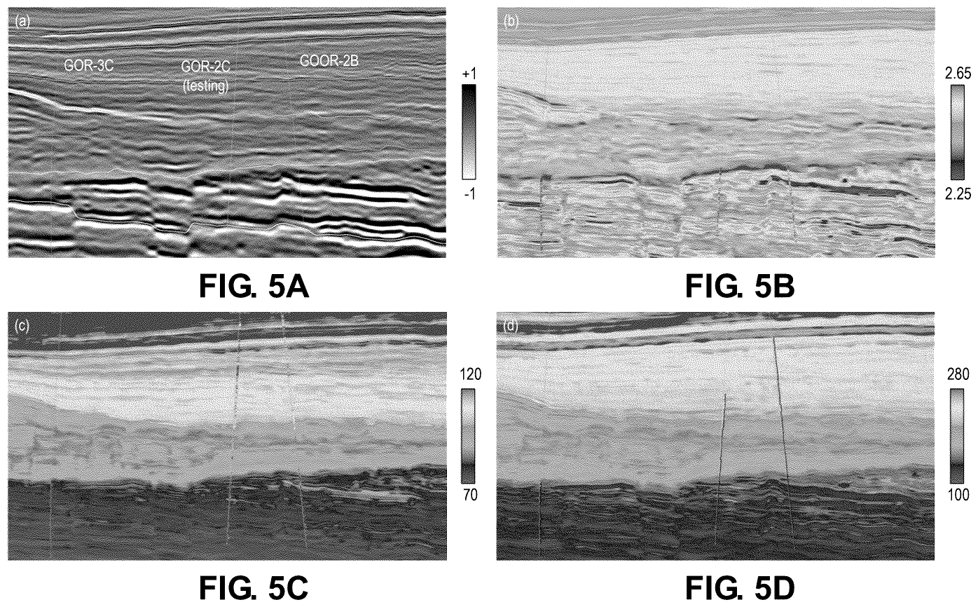

FIG. 3 illustrates a method 300 for performing a ML-assisted elastic FWI, according to an embodiment. An illustrative order of the method 300 is provided below; however, one or more portions of the method 300 may be performed in a different order, simultaneously, repeated, or omitted. At least a portion of the method 300 may be performed with a computing system (described below). In the method 300, FIG. 5A is the seismic image, which is used in machine learning workflow to estimate the elastic properties—FIG. 5B (rho), FIG. 5C (1/Vp), and FIG. 5D (1/Vs). Therefore, FIGS. 5B and 5D are used in the method 300 as the initial model of rho and Vs.

The method 300 may include generating an initial P wave velocity model, as at 305. In an example, a velocity tomography or velocity model building process may be implemented to obtain a kinematically accurate but relatively smooth P wave velocity model Vp. This velocity model Vp may be input into the elastic FWI engine as the initial P wave velocity model.

The method 300 may also include producing a subsurface seismic image and/or an image gather based upon the initial P wave velocity model, as at 310. For example, before the elastic FWI process is launched, the initial Vp model may be input into a migration engine (e.g., either Kirchhoff migration, one-way wave equation migration, beam migration, or reverse time migration (RTM), or any other imaging engine) to produce the subsurface seismic image and/or image gather.

The method 300 may also include interpreting the subsurface seismic image or the image gather to produce a stratigraphy model, as at 315. More particularly, the subsurface seismic image may be interpreted (e.g., horizon picking, fault system picking, relative geologic time (RGT) model generation, facies classification, etc.) to produce the stratigraphy model.

The method 300 may include estimating elastic properties based upon the subsurface seismic image or the image gather and the stratigraphy model, as at 320. More particularly, the seismic image, image gather, and/or the stratigraphy model may be input into a machine learning (ML) neural network (NN) to estimate the elastic properties (e.g., as Vp, Vs, density Rho) in the entire spatial domain or time domain by utilizing available well logs located in that spatial domain. In other words, the neural network maps the traces extracted from the seismic image and/or image gather to the well log data located at the same locations, with the constraints from the stratigraphy model, which is the network training process. In one embodiment, inputting the stratigraphy model may be optional (e.g., omitted).

The method 300 may include processing the elastic properties to produce processed elastic properties, as at 325. More particularly, the trained neural network may be applied to the entire image domain to estimate the 3D elastic property models (e.g., Vp, Vs, and Rho). The estimated 3D models Vs and Rho may be processed (e.g., using a smoothing and/or denoising process) to make them suitable for the subsequent elastic FWI update.

The method 300 may include performing elastic full wave inversion (FWI) on the initial P wave velocity model and/or the processed elastic properties to produce updated elastic properties, as at 330. More particularly, the processed Vs and Rho may be input into the elastic FWI engine, along with the Vp, to start the elastic FWI process. During the elastic FWI process, the Vp model may be updated iteratively. The Vs and Rho models can be updated iteratively as well or just be fixed without updating.

When elastic FWI is performed, the S wave velocity estimated by the neural network may be used as the initial S wave velocity model for the FWI. The density estimated by the neural network may also be used as the initial density model for the FWI. The initial S wave velocity model and the initial density model can be updated by the FWI engine during the FWI process. They can also be fixed during the FWI process. In an embodiment, the P wave velocity estimated by the neural network may not be used as the initial model for the FWI. Instead, a tomography P velocity model or a P velocity model obtained using other velocity model building workflow may be used as the initial P wave velocity model for the elastic FWI.

The method 300 may also include performing one or more additional iterations of estimating the elastic properties, processing the elastic properties, and/or performing the elastic FWI in response to the updated elastic properties, the updated subsurface seismic image, and/or the updated image gather failing to meet a predetermined threshold, as at 335. The one or more additional iterations may be performed until the updated elastic properties, the updated subsurface seismic image, and/or the updated image gather meet the predetermined threshold. More particularly, after one or a certain number of FWI iterations, the updated Vp model (and the Vs and/or Rho models if they are updated) may be examined. If the results are satisfactory, the ML-assisted elastic FWI is finished. A migration may also be implemented using the ML-assisted elastic FWI Vp model to produce the new subsurface seismic image/image gathers. If the image and the image gathers are satisfactory, the ML-assisted elastic FWI is finished. If the elastic FWI data residual decreases during the FWI iterations and reaches a predetermined small value, the ML-assisted elastic FWI may be regarded as successful convergence. On the other hand, if the resulting elastic FWI velocity models and/or image/image gathers are not satisfactory, or the elastic FWI data residual does not decrease to a predetermined small value, another round of ML-driven elastic property model estimation may be implemented to produce new Vp, Vs, and Rho. The new Vs and Rho may be input into the elastic FWI engine to start another round of elastic FWI. This process may be repeated until the elastic FWI results meet the predetermined target/standard.

The method 300 may also include producing an updated subsurface seismic image and/or an updated image gather based upon the updated elastic properties. The updated subsurface seismic image and/or the updated image gather may be produced based upon the updated P wave velocity model.

The method 300 may also include displaying outputs. The outputs may be or include the 3D elastic property models (e.g., Vp, Vs, and Rho), the updated elastic property models, the ML-assisted elastic FWI Vp model, the new elastic property models, the updated subsurface seismic image, the update image gather, or a combination thereof.

In one embodiment, the workflow 300 may also include performing a wellsite action. The wellsite action may be based upon or in response to the 3D elastic property models (e.g., Vp, Vs, and Rho), the updated elastic property models, the ML-assisted elastic FWI Vp model, the new elastic property models, the updated subsurface seismic image, the update image gather, or a combination thereof. The wellsite action may be or include generating and/or transmitting a signal (e.g., using a computing system) that recommends, instructs, or causes a physical action to occur at a wellsite. The wellsite action may also or instead include performing the physical action at the wellsite. The physical action may include selecting where to drill a wellbore, drilling the wellbore, varying a weight and/or torque on a drill bit that is drilling the wellbore, varying a drilling trajectory of the wellbore, varying a concentration and/or flow rate of a fluid pumped into the wellbore, or the like.

In the ML-assisted workflow shown in FIG. 3, the initial Vp model for FWI may be obtained by tomography. This initial Vp model may also be used in the migration to obtain the subsurface seismic images for the subsequent ML-driven elastic property estimation. However, there are other approaches to obtain the initial Vp model. The quality of the resulting subsurface seismic image may be dependent on the specific approach that is used to build the initial Vp model. A kinematically inaccurate Vp model leads to suboptimal seismic images. However, these non-ideal seismic images can still be used for the ML-driven elastic property model estimation, although the estimated property models (e.g., Vs, Rho) may be re-estimated after a certain number of FWI iterations.

In the ML-assisted workflow shown in FIG. 3, the subsurface seismic images can be produced by using different types of migration algorithms such as time migration, Kirchhoff depth migration, one-way wave equation migration, beam migration, or RTM, or any other imaging algorithm. Time-to-depth conversion of depth-to-time conversion may make the seismic images and the well logs in the same domain.

Neural Network for Elastic Property Model Building from Seismic Image Gathers

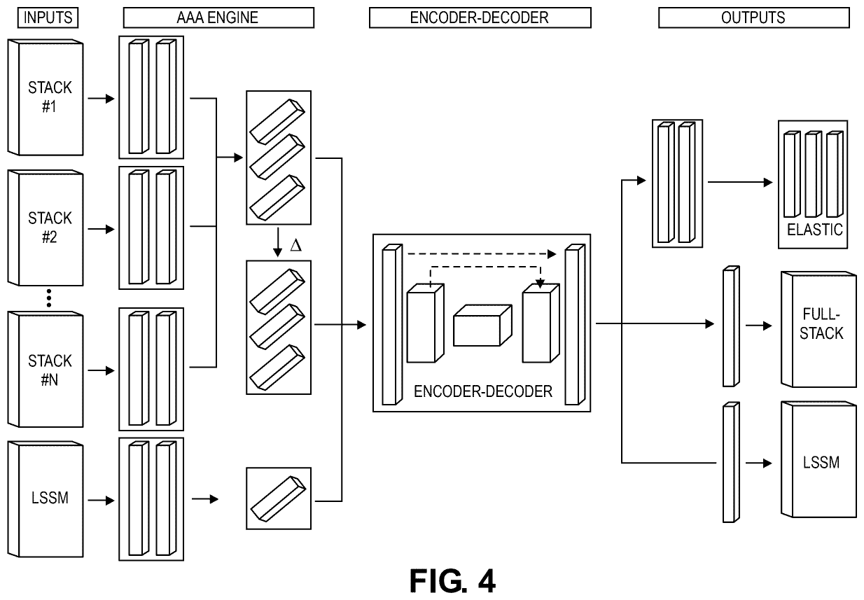

FIG. 4 illustrates a schematic view of a neural network for elastic property model building from seismic image gathers, according to an embodiment. More particularly, FIG. 4 illustrates the input into the network and the output from the network. The input of the network may include multiple channels. Each channel (e.g., from #1-#N) represents one image gather (e.g., either an angle gather, offset gather, or any other type of gather). Another channel of the input is the large-scale structural model, stratigraphy model, or any other model containing the subsurface structural information. The output of the network includes the elastic properties such as Vp, Vs, and Rho.

During the training phase, the elastic properties predicted by the neural network may be compared with the well logs at the well locations, and the difference (e.g., residual) may be backpropagated to update the parameters of the neural network.

### Input Seismic Image and Output Elastic Properties

FIG. 5A illustrates a seismic image that may be input into the network, FIG. 5B illustrates an image showing the Rho, FIG. 5C illustrates an image showing the predicted P-slowness (1/Vp), and FIG. 5D illustrates an image showing the S-slowness (1/Vs), according to an embodiment. In the ML-assisted method shown in FIG. 3, in the elastic FWI module, Vp can be updated during the FWI process, Vs can be updated as well or fixed as the initial Vs model predicted by the ML-driven elastic property estimation network, and Rho can be updated or fixed as the initial Rho model predicted by the network or fixed as a constant value. In another embodiment, Rho can be estimated from the Vp using the Gardner law.

During the elastic FWI process, different strategies can be employed. For example, the migration may be implemented to produce the seismic image after the elastic FWI converges. The seismic image may then be used to estimate the Vs and Rho. The migration can also be used to estimate the Vs and Rho using the neural network after a certain number of FWI iterations before the FWI converges.

Well log data may be improved via preprocessing (e.g., down-sampling or smoothing to reduce the resolution). The seismic images used for the elastic property estimation may be improved using a preconditioning process to remove the noise and the artifacts. Any useful and reliable a priori information of the subsurface condition may be added as an extra input channel of the neural network for the elastic property model building.

In an example, the ML-assisted elastic FWI method 300 can be implemented using different frequency bands of the seismic data. For example, the seismic data between 2 Hz and 5 Hz can be extracted first and used to run the ML-assisted elastic FWI to obtain an updated Vp model. The updated Vp model can serve as the initial Vp model for the 2 Hz-8 Hz ML-assisted elastic FWI. Similarly, the Vp model obtained from 2 Hz-8 Hz ML-assisted elastic FWI can serve as the initial Vp model for the subsequent 2 Hz-12 Hz ML-assisted elastic FWI.

### Exemplary Computing System

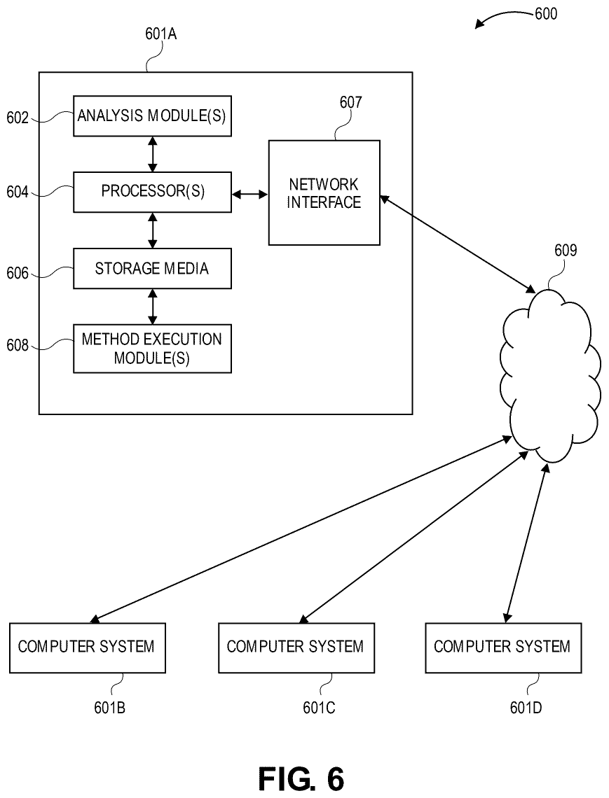

In some embodiments, the methods of the present disclosure may be executed by a computing system. FIG. 6 illustrates an example of such a computing system 600, in accordance with some embodiments. The computing system 600 may include a computer or computer system 601A, which may be an individual computer system 601A or an arrangement of distributed computer systems. The computer system 601A includes one or more analysis modules 602 that are configured to perform various tasks according to some embodiments, such as one or more methods disclosed herein. To perform these various tasks, the analysis module 602 executes independently, or in coordination with, one or more processors 604, which is (or are) connected to one or more storage media 606. The processor(s) 604 is (or are) also connected to a network interface 607 to allow the computer system 601A to communicate over a data network 609 with one or more additional computer systems and/or computing systems, such as 601B, 601C, and/or 601D (note that computer systems 601B, 601C and/or 601D may or may not share the same architecture as computer system 601A, and may be located in different physical locations, e.g., computer systems 601A and 601B may be located in a processing facility, while in communication with one or more computer systems such as 601C and/or 601D that are located in one or more data centers, and/or located in varying countries on different continents).

A processor may include a microprocessor, microcontroller, processor module or subsystem, programmable integrated circuit, programmable gate array, or another control or computing device.

The storage media 606 may be implemented as one or more computer-readable or machine-readable storage media. Note that while in the example embodiment of FIG. 6 storage media 606 is depicted as within computer system 601A, in some embodiments, storage media 606 may be distributed within and/or across multiple internal and/or external enclosures of computing system 601A and/or additional computing systems. Storage media 606 may include one or more different forms of memory including semiconductor memory devices such as dynamic or static random access memories (DRAMs or SRAMs), erasable and programmable read-only memories (EPROMs), electrically erasable and programmable read-only memories (EEPROMs) and flash memories, magnetic disks such as fixed, floppy and removable disks, other magnetic media including tape, optical media such as compact disks (CDs) or digital video disks (DVDs), BLURAY® disks, or other types of optical storage, or other types of storage devices. Note that the instructions discussed above may be provided on one computer-readable or machine-readable storage medium, or may be provided on multiple computer-readable or machine-readable storage media distributed in a large system having possibly plural nodes. Such computer-readable or machine-readable storage medium or media is (are) considered to be part of an article (or article of manufacture). An article or article of manufacture may refer to any manufactured single component or multiple components. The storage medium or media may be located either in the machine running the machine-readable instructions, or located at a remote site from which machine-readable instructions may be downloaded over a network for execution.

In some embodiments, computing system 600 contains one or more method execution module(s) 608. In the example of computing system 600, computer system 601A includes the method execution module 608. In some embodiments, a single method execution module may be used to perform some aspects of one or more embodiments of the methods disclosed herein. In other embodiments, a plurality of method execution modules may be used to perform some aspects of methods herein.

It should be appreciated that computing system 600 is merely one example of a computing system, and that computing system 600 may have more or fewer components than shown, may combine additional components not depicted in the example embodiment of FIG. 6, and/or computing system 600 may have a different configuration or arrangement of the components depicted in FIG. 6. The various components shown in FIG. 6 may be implemented in hardware, software, or a combination of both hardware and software, including one or more signal processing and/or application specific integrated circuits.

Further, the steps in the processing methods described herein may be implemented by running one or more functional modules in information processing apparatus such as general purpose processors or application specific chips, such as ASICs, FPGAs, PLDs, or other appropriate devices. These modules, combinations of these modules, and/or their combination with general hardware are included within the scope of the present disclosure.

Computational interpretations, models, and/or other interpretation aids may be refined in an iterative fashion; this concept is applicable to the methods discussed herein. This may include use of feedback loops executed on an algorithmic basis, such as at a computing device (e.g., computing system 600, FIG. 6), and/or through manual control by a user who may make determinations regarding whether a given step, action, template, model, or set of curves has become sufficiently accurate for the evaluation of the subsurface three-dimensional geologic formation under consideration.

The foregoing description, for purposes of explanation, has been described with reference to specific embodiments. However, the illustrative discussions above are not intended to be exhaustive or limiting to the precise forms disclosed. Many modifications and variations are possible in view of the above teachings. Moreover, the order in which the elements of the methods described herein are illustrated and described may be re-arranged, and/or two or more elements may occur simultaneously. The embodiments were chosen and described in order to best explain the principles of the disclosure and its practical applications, to thereby enable others skilled in the art to best utilize the disclosed embodiments and various embodiments with various modifications as are suited to the particular use contemplated.

What is claimed is:

1. A method for performing an elastic full wave inversion (FWI), the method comprising:
generating an initial P wave velocity model;
producing a subsurface seismic image or an image gather based upon the initial P wave velocity model;
estimating elastic properties based upon the subsurface seismic image or the image gather; and
performing elastic full wave inversion (FWI) on the initial P wave velocity model and the elastic properties to produce updated elastic properties.

2. The method of claim 1, wherein the initial P wave velocity model is generated using velocity tomography or a velocity model building process.

3. The method of claim 1, wherein the subsurface seismic image or the image gather is produced using a migration engine, and wherein the migration engine comprises a Kirchhoff migration engine, a one-way wave equation migration engine, a beam migration engine, or a reverse time migration engine.

4. The method of claim 1, wherein the elastic properties comprise an estimated S wave velocity model and/or an estimated density model.

5. The method of claim 4, wherein the updated elastic properties comprise an updated P wave velocity model.

6. The method of claim 5, wherein the updated elastic properties also comprise an updated S wave velocity model, and/or an updated density model.

7. The method of claim 5, further comprising producing an updated subsurface seismic image and/or an updated image gather based upon the updated elastic properties, wherein the updated subsurface seismic image and/or the updated image gather are produced based upon the updated P wave velocity model.

8. The method of claim 1, wherein the elastic properties are estimated in a spatial domain or a time domain by utilizing well log data located in the spatial domain or the time domain, wherein estimating the elastic properties comprises mapping traces extracted from the subsurface seismic image or the image gather to the well log data located at the same locations in a network training phase to produce a trained network, and wherein the trained network is applied to the traces extracted from the subsurface seismic image or image gathers to map them to the corresponding elastic properties.

9. The method of claim 1, further comprising displaying the updated elastic properties.

10. The method of claim 1, further comprising performing a wellsite action based upon or in response to the updated elastic properties.

11. A computing system, comprising:
one or more processors; and
a memory system comprising one or more non-transitory computer-readable media storing instructions that, when executed by at least one of the one or more processors, cause the computing system to perform operations, the operations comprising:
generating an initial P wave velocity model, wherein the initial P wave velocity model is generated using velocity tomography or a velocity model building process;
producing a subsurface seismic image or an image gather based upon the initial P wave velocity model, wherein the subsurface seismic image or the image gather is produced using a migration engine;
estimating elastic properties based upon the subsurface seismic image or the image gather, wherein the elastic properties are estimated using a machine learning (ML) neural network (NN), wherein the elastic properties comprise an estimated S wave velocity model and/or an estimated density model;
performing elastic full wave inversion (FWI) on the initial P wave velocity model and the elastic properties to produce updated elastic properties, and wherein the updated elastic properties comprise an updated P wave velocity model; and
producing an updated subsurface seismic image and/or an updated image gather based upon the updated elastic properties, wherein the updated subsurface seismic image and/or the updated image gather are produced based upon the updated P wave velocity model.

12. The computing system of claim 11, wherein the operations further comprise interpreting the subsurface seismic image or the image gather to produce a stratigraphy model, and wherein the elastic properties are also estimated based upon the stratigraphy model.

13. The computing system of claim 12, wherein the subsurface seismic image or the image gather are interpreted using horizon picking, fault system picking, relative geologic time model generation, or facies classification.

14. The computing system of claim 11, wherein the operations further comprise processing the elastic properties to produce processed elastic properties, and wherein the elastic FWI is performed on the processed elastic properties.

15. The computing system of claim 14, wherein processing comprises smoothing, denoising, or both.

16. A non-transitory computer-readable medium storing instructions that, when executed by one or more processors of a computing system, cause the computing system to perform operations, the operations comprising:
generating an initial P wave velocity model, wherein the initial P wave velocity model is generated using velocity tomography or a velocity model building process;
producing a subsurface seismic image or an image gather based upon the initial P wave velocity model, wherein the subsurface seismic image or the image gather is produced using a migration engine, and wherein the migration engine comprises a Kirchhoff migration engine, a one-way wave equation migration engine, a beam migration engine, or a reverse time migration engine;
interpreting the subsurface seismic image or the image gather to produce a stratigraphy model, wherein the subsurface seismic image or the image gather is interpreted using horizon picking, fault system picking, relative geologic time model generation, or facies classification;
estimating elastic properties based upon the subsurface seismic image or the image gather and the stratigraphy model, wherein the elastic properties are estimated using a machine learning (ML) neural network (NN), wherein the elastic properties comprise an estimated S wave velocity model and an estimated density model, wherein the elastic properties are estimated in a spatial domain or a time domain by utilizing well log data located in the spatial domain or the time domain, and wherein estimating the elastic properties comprises mapping traces extracted from the subsurface seismic image or the image gather to the well log data located at the same locations in a network training phase with constraints from the stratigraphy model to produce a trained network, and wherein the trained model is then applied to the traces from the subsurface seismic image or image gathers to map them into the corresponding elastic properties;
processing the elastic properties to produce processed elastic properties, wherein processing comprises smoothing, denoising, or both;
performing elastic full wave inversion (FWI) on the initial P wave velocity model and the processed elastic properties to produce updated elastic properties, wherein the updated elastic properties comprise an updated P wave velocity model, an updated S wave velocity model, and/or an updated density model, and wherein the elastic FWI is not performed on an estimated P wave velocity model; and
producing an updated subsurface seismic image and/or an updated image gather based upon the updated elastic properties, wherein the updated subsurface seismic image and/or the updated image gather are produced based upon the updated P wave velocity model.

17. The non-transitory computer-readable medium of claim 16, wherein the operations further comprise performing one or more additional iterations of estimating the elastic properties, processing the elastic properties, and performing the elastic FWI in response to the updated elastic properties, the updated subsurface seismic image, and/or the updated image gather failing to meet a predetermined threshold, wherein the one or more additional iterations are performed until the updated elastic properties, the updated subsurface seismic image, and/or the updated image gather meet the predetermined threshold.

18. The non-transitory computer-readable medium of claim 16, wherein the operations further comprise displaying the updated elastic properties, the updated subsurface seismic image, and/or the updated image gather.

19. The non-transitory computer-readable medium of claim 16, wherein the operations further comprise performing a wellsite action in response to the updated elastic properties, the updated subsurface seismic image, and/or the updated image gather, wherein the wellsite action comprises generating and/or transmitting a signal that recommends, instructs, or causes a physical action to occur, and wherein the physical action comprises selecting where to drill a wellbore, drilling the wellbore, varying a weight and/or torque on a drill bit that is drilling the wellbore, varying a drilling trajectory of the wellbore, varying a concentration and/or a flow rate of a fluid pumped into the wellbore, and/or varying a pressure in the wellbore.

20. The non-transitory computer-readable medium of claim 16, wherein the elastic FWI is performed iteratively such that the initial P wave velocity model is used to perform a first iteration of the elastic FWI in a first frequency band to produce the updated P wave velocity model, which then serves as the initial P wave velocity model that is used to perform a second iteration of the elastic FWI in a second, different frequency band to produce the a further updated P wave velocity model.
